(19) United States
(12) Patent Application Publication
(10) Pub. No.: US 2024/0273115 A1
(43) Pub. Date: Aug. 15, 2024

(54) METHODS AND SYSTEMS FOR SPLITTABLE, NON-FUNGIBLE TOKENS IN A MULTIPLE DISTRIBUTED LEDGER SYSTEM

(71) Applicant: TBCASOFT, INC., Sunnyvale, CA (US)

(72) Inventors: Kaibin HUANG, New Taipei City (TW); Yuan-Shiang CHANG, Taipei City (TW); William WU, Sunnyvale, CA (US)

(21) Appl. No.: 18/440,015

(22) Filed: Feb. 13, 2024

Related U.S. Application Data
(60) Provisional application No. 63/484,742, filed on Feb. 13, 2023.

(51) Int. Cl. G06F 16/27; G06Q 20/38

(52) U.S. Cl. CPC G06F 16/27; G06Q 20/389

(57) ABSTRACT

The present invention relates to methods for splittable non-fungible tokens (NFTs) with cross-ledger ability in a multiple distributed ledger system. The method comprises steps of: identifying from the source distributed ledger, a source NFT having a source NFT information comprising a splitting rule and a genesis NFT identifier; locking or burning, by a locking transaction, the source NFT in the source distributed ledger; and unlocking or minting, by a completing transaction, a target NFT corresponding to the source NFT in the target distributed ledger. The target NFT may also comprises the source NFT information to enable splitting or merging of the target NFT in the target distributed ledger.

### RELATED APPLICATION

This application claims the benefit of the U.S. Provisional Application No. 63/484,742 filed on Feb. 13, 2023, titled “A SPLITTABLE, SELF-EVOLVED NFT TOKEN AND METHODS THEREOF,” which is incorporated herein by reference at its entirety.

### BACKGROUND OF THE INVENTION

### Field of the Invention

The present invention relates to methods and systems to provide splittable non-fungible tokens (NFTs) with cross-ledger ability in a multiple distributed ledger system.

### Description of Related Art

A distributed ledger is the consensus of replicated, shared, and synchronized digital data that is geographically spread (distributed) across many sites. It does not require a central administrator, and consequently does not have a single (central) point-of-failure. The most common form of distributed ledger technology is the blockchain, which is a distributed ledger with growing lists of records that are securely linked together via cryptographic hashes. Each block in a blockchain contains a cryptographic hash of the previous block, a timestamp, and transaction data. Because of its sequential nature, blockchain transactions are irreversible in that, once they are recorded, the data in any given block cannot be altered retroactively without altering all subsequent blocks.

Both fungible tokens and non-fungibles token may be issued and recorded on a distributed ledger based on the ledger's settings. Fungible tokens are digital assets which are divisible and non-unique. On the other hands, a non-fungible token (NFT) is a unique digital identifier that is recorded on a blockchain and is used to certify ownership and authenticity. An NFT generally cannot be copied, substituted, or subdivided. The ownership of an NFT is recorded in the blockchain and can be transferred by the owner, allowing NFTs to be sold and traded. NFTs typically contain references to digital files such as artworks, photos, videos, and audio. Because NFTs are uniquely identifiable, they differ from cryptocurrencies, which are fungible.

Because of the uniqueness of every single NFT and the non-fungible nature, the prices of NFTs in some highly acclaimed projects are pushed up to astonishingly high values. This essentially prevents the general public from buying those highly acclaimed NFTs, since an NFT usually can only be purchased and owned as a whole in the blockchain.

### SUMMARY OF THE INVENTION

Provided herein are methods for splittable non-fungible tokens (NFTs), especially for splittable NFTs with cross-ledger ability in a multiple distributed ledger system.

The method for transferring splittable, non-fungible tokens (NFTs) from a source distributed ledger to a target distributed ledger different from the source distributed ledger, comprising steps of: identifying from the source distributed ledger, a source NFT having a source NFT information comprising a splitting rule and a genesis NFT identifier; locking or burning, by a locking transaction, the source NFT in the source distributed ledger; and unlocking or minting, by a completing transaction, a target NFT corresponding to the source NFT in the target distributed ledger. The target NFT may comprise the source NFT information to enable splitting or merging of the target NFT in the target distributed ledger.

In one embodiment, before locking or burning the source NFT by the locking transaction, the method further comprising steps of: generating and submitting an initiating transaction for commission to the target distributed ledger, wherein the initiating transaction comprises the target NFT; and generating and submitting the locking transaction for commission to the source distributed ledger. And before unlocking or minting the target NFT by the completing transaction, the method further comprising steps of: referencing, by the locking transaction, the initiating transaction in the target distributed ledger to verify the existence of the initiating transaction; and generating and submitting the completing transaction for commission to the target distributed ledger.

In one embodiment, the splitting of the target NFT comprises the steps of: after receiving a splitting request complying with the splitting rule, locking or burning the target NFT in the target distributed ledger; and based on the genesis NFT identifier and the splitting request, generating a plurality of split NFTs each having a split NFT information comprising at least part of the source NFT information. The split NFT information of each of the plurality of split NFTs may comprise the splitting rule and the genesis NFT identifier.

In one embodiment, the merging of the target NFT comprises the steps of: receiving a merging request to merge the target NFT with one or more sibling NFTs having the same genesis NFT identifier and the same owner as the target NFT; locking or burning the target NFT and the one or more sibling NFTs in the target distributed ledger; and generating a merged NFT having a merged NFT information comprising at least part of the source NFT information. In this embodiment, the merged NFT information of the merged NFT may comprise the splitting rule and the genesis NFT identifier.

In one embodiment, both the source NFT and the target NFT are referenced to a genesis NFT having the genesis NFT identifier and the splitting rule; and the genesis NFT is the first minted NFT among all NFTs having the genesis NFT identifier. The source NFT may be the genesis NFT, and it is also possible that neither the source NFT nor the target NFT are the genesis NFT. In a specific embodiment, the genesis NFT identifier is the token ID of the genesis NFT. In a specific embodiment, the splitting rule determines a smallest splitting unit of the genesis NFT. The smallest splitting unit may be determined by a horizontal segmentation number and a vertical segmentation number. Also, the splitting rule may further comprise a splitting times which determines a maximum number of times the genesis NFT can be split.

In one embodiment, the genesis NFT is configured to be split into a plurality of child NFTs based on the splitting rule, and each of the plurality of child NFTs comprises one or more smallest splitting units of the genesis NFT. The metadata of the genesis NFT may comprise a genesis image, and the metadata of each of the plurality of child NFTs comprises a child image represents a portion of the genesis image.

In one embodiment, the locking transaction locks the source NFT in a smart contract for transferring splittable NFTs from a source distributed ledger to a target distributed ledger. The locked source NFT is unlocked only after a foreign distributed ledger requests to transfer a foreign NFT corresponding to the source NFT from the foreign distributed ledger to the source distributed ledger. The foreign distributed ledger may be the same as the target distributed ledger, or it may be different from the distributed ledger.

In an embodiment, a three-transaction cross-ledger transfer is performed. These transactions include an initiating transaction in the target distributed ledger; a locking transaction in the source distributed ledger; and a completing transaction in the target distributed ledger. In a specific embodiment, the target NFT generated in the initiating transaction is only transferrable by the completing transaction when the completing transaction references the locking transaction and when the target NFT information of the target NFT in the initiating transaction matches with the source NFT information of the source NFT identified in the source distributed ledger. In this embodiment, the completing transaction may use a Merkle tree reference to reference the locking transaction.

In a specific embodiment performing three-transaction cross-ledger transfer, the method is performed by a node-stack of the source distributed ledger. In this embodiment, the initiating transaction and the completing transaction are submitted to a node-stack of the target distributed ledger, and the node-stack of the target distributed ledger further submits the initiating and completing transactions to the target distributed ledger.

In a specific embodiment performing three-transaction cross-ledger transfer, the method is performed by a node-stack of the target distributed ledger. In this embodiment, the locking transaction is submitted to a node-stack of the source distributed ledger, and the node-stack of the source distributed ledger further submits the locking transaction to the source distributed ledger.

Other objectives, advantages and novel features of the invention will become more apparent from the following detailed description when taken in conjunction with the accompanying drawings.

### BRIEF DESCRIPTION OF THE DRAWINGS

FIG. 1 shows the functionalities of a smart contract in the present invention.

FIG. 2 shows the split-merge of a series of NFTs derived from a genesis NFT.

FIG. 3 shows that a minted NFT may be split or burned in the future.

FIG. 4 shows that a parent NFT, NFT.CD is split into two child NFTs, NFT.C and NFT.D. NFT.C and NFT.D are generated, and the status of NFT.CD is changed into “Split”.

FIG. 5 shows that two NFTs, NFT.A and NFT.B, are merged into a merged NFT, NFT.AB. NFT.AB is generated, and the status of NFT.A and NFT.B are changed into “Merged”.

FIG. 6 shows the data schema of an NFT in the present invention.

FIG. 7 shows the data schema of an NFT in the present invention with blockchain memory as another part of on-chain data.

FIGS. 8A and 8B show an example of NFT linked with a fine art in a museum. FIG. 8A shows a genesis NFT split into three child NFTs, and FIG. 8B shows two of the three child NFTs in FIG. 8A are merged together to form a merged NFT.

FIG. 9 shows an example of data stored on blockchain. The data comprise three parts: blockchain data, blockchain memory, and off-chain data.

FIGS. 10A-10D show the data of an NFT to be split and three generated child NFTs. FIG. 10A shows the data changes of the genesis NFT in FIG. 8A after split and inactivated; FIGS. 10B, 10C and 10D are the data of three child NFTs in FIG. 8A.

FIGS. 11A-11C show the data of two NFTs to be merged together and the merged NFT. FIGS. 11A and 11B show the data changes of the two NFTs to be merged in FIG. 8B after merging; FIG. 11C shows the data of the merged NFT in FIG. 8B.

FIGS. 12A-12B show the data changes of NFT after a leasement is started and revoked. FIG. 12A shows the data changes in NFT leasement for the NFT of index 2 in FIG. 8A, and FIG. 12B shows the data changes when the leasement is revoked.

FIGS. 13-14 show functional calls implemented in the example shown in FIGS. 8-12. FIG. 13 lists ERC721 functions, and FIG. 14 lists customized functions.

FIG. 15 shows a method of three-transaction cross-ledger transfer which prevents double spending.

FIG. 16 shows a system architecture embedding foreign payment verification (PV) nodes into distributed ledger networks.

FIG. 17 shows a system architecture utilizing a set of shared full nodes while not having every node be a shared node.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), graphics processing units (GPUs), etc. This application relates to methods for splittable non-fungible tokens (NFTs), which are especially suitable for splittable NFTs with cross-ledger ability in a multiple distributed ledger system.

### Splittable NFT

The following provides an authentic and self-evolved NFT token with new functionalities. “Authentic” means the NFTs may bind to some physical/virtual assets, and there will be an authority who can judge the genuineness between NFTs and assets. “Self-evolved” means each NFT is able to generate a series of next generation NFTs, and the generated NFTs inherit several parts of features, attributes and privileges from the original NFT. Moreover, operations among NFT in the same/different generations are eligible to support various blockchain based operations and functionalities. These may include new function such as NFT leasing. The whole history of generations and operations will be recorded distributedly by the nature of blockchain. That is, the NFT life cycle will be faithfully written in the distributed ledgers.

In one example, fine arts in museums can be minted into an NFT. A museum obviously has the capability of specifying the authenticity if duplicated NFTs occur. The NFT representing a fine art may be designed in a way that is capable of digitally splitting into several portions, each of them inheriting some properties from the origin NFT, such as the capability of being transferred, rented, borrowed or split into more NFTs. In contrast to splitting, the operation of merging may also be provided to generate a new NFT from two or more existing NFTs from the same original NFT. All functions including splitting and merging are implemented as specific transactions over the blockchain platform. By the nature of the blockchain environment, the NFT will evolve into a bunch of transaction history.

This NFT platform is designed to be with following functions: (1) the property owners (e.g., museums) can issue NFTs based on their assets after the ownership provement; (2) several platform-wide functions are attached to the minted NFTs, such as token minting, transferring, burning, splitting, merging, leasing, revoking and returning; and (3) the NFT trading can be defined with different trading models, such as transfer, buy/sell, or lease. The above functions are implemented in decentralized ledgers (blockchains), which may be supported by smart contracts deployed on the decentralized ledgers. A smart contract is a piece of software deployed on the decentralized ledgers whose states are distributed but synchronized. The smart contracts in the NFT platform may implement NFT-related functions such as those described in ERC-721 standard. In addition, the smart contracts may implement some customized functions to provide special features like split-merge functions and leasing functions.

In one example, three kinds of participants are enrolled in this system: (1) administrator (Admin); (2) user; and (3) smart contract. Preferably, this system is implemented on a private blockchain, which is a decentralized distributed ledger operated by a single entity or a group of participants that can control access to the network.

In this system, the administrators stand for the system builder and maintainers. Besides system (including the smart contracts) building and maintenance, the main responsibility of the administrators is the membership control that allows or declines new members' enrollment.

The users are the main participants in this system. Their entrance to this system is controlled by the administrators. A user may interact with other users or the smart contracts.

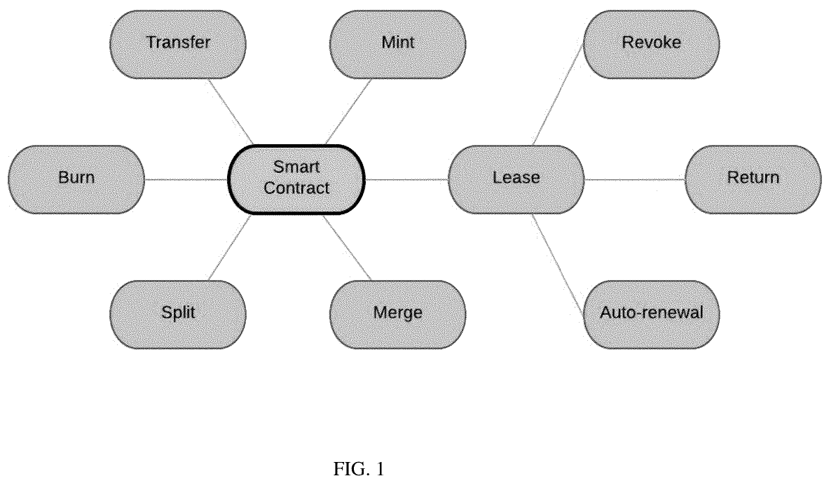

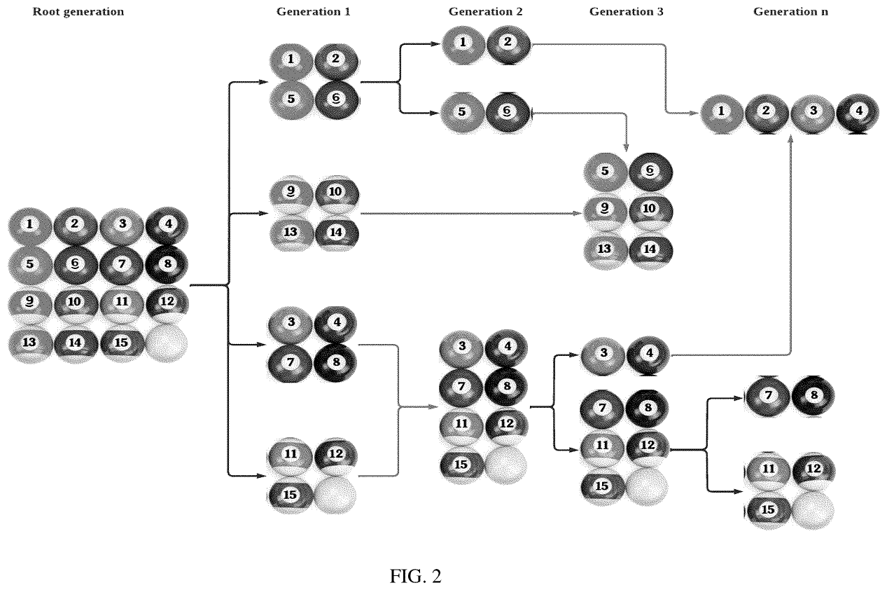

The smart contracts are immutable code segments deployed by administrators. Once deployed, blockchain nodes will faithfully execute the smart contract codes in a distributed manner. By the nature of distributed ledgers, those deployed smart contracts cannot be modified or withdrawn even by the administrators themselves. With this immutability, users can trust and interact with these smart contracts to handle their digital assets, which is synchronized, immutable and asset sustainable. The functionalities of a smart contract in this system are shown in FIG. 1. The smart contracts are developed and deployed by the administrators. In one embodiment, the ERC 721 contract with additional customized functionalities are deployed.

### Smart Contract Functionalities

As described above, the smart contracts enabling NFT splitting and merging have both ERC 721 functions and customized functions. The functions following ERC 721 standard include token generation, transfer or burning. Customized functions include token splitting and merging.

In token generation (or “Mint” function), a user enters the detailed information of a digital asset to the system, then the smart contract will return an NFT token, which corresponds to a real asset owned by the user (e.g., a fine-art owned by a museum). To provide authenticity, there must be an entity to control the issuance of new NFTs. In an embodiment, the user sends API calls to the administrator, and the administrator implements the membership control that allow some specific users (e.g. museums) to mint, and decline other general users. For those approved users, the administrator will redirect the mint query to the blockchain. The initialized owner of the minted NFT token is the user. The newly minted NFT tokens are called “genesis NFTs”.

Once minted, the owners may transfer their NFTs to other users directly or indirectly with the aid of smart contract using Transfer function. Furthermore, the minted NFTs may be burned by the Burn function at the end of their life cycle. This might occur in some based on smart contracts' settings or smart contracts updated.

Besides ERC 721 standard, some customized smart contract functions, such as “Split” and “Merge”, are defined to manipulate digital assets in this system. The “Split” function is configured to split a digital asset into several segments. The split child assets, in the form of child NFTs, originally belong to the same owner as the parent NFT.

The “Merge” function is configured to merge several digital assets (NFTs) into a single merged digital asset (merged NFT) once a user collects several segments split from the same genesis NFT.

With the aid of those operations, all NFTs become self-evolving digital assets that keep generating child NFTs during their life cycle. The whole life cycles of NFT tokens are faithfully recorded among distributed ledgers. The attributes and privileges of parent NFTs are intuitively inherited by new generations of child NFTs, as shown in FIG. 2.

### Life Cycle of Tokens

The life cycle of the NFT may begin from Mint, Split or Merge functions, which are illustrated below in more details.

(1) Mint an NFT from Metadata

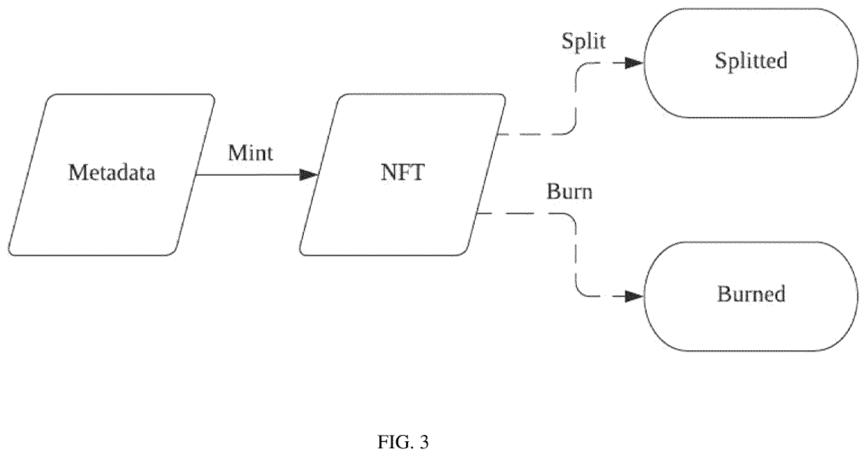

In this step, a “genesis NFT” is generated. A genesis NFT is created from a minting step without any prior splitting or merging steps. This is the common case where an NFT comes from the minting process operated by a minter/user. The minted NFT may be further split or burned in the future if desired or necessary, as shown in FIG. 3.

(2) Split an NFT into New NFTs

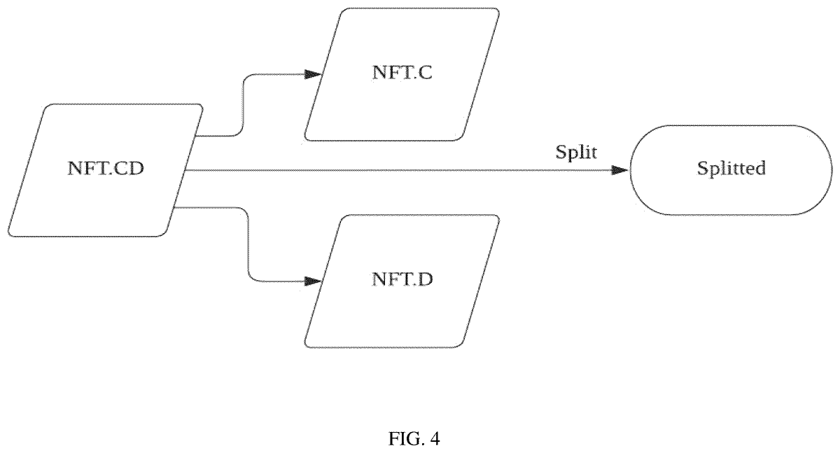

An NFT may be split into several different parts which are also NFTs. Take the flowchart in FIG. 4 for example, in the process that NFT.CD splits into NFT.C and NFT.D, the following events occur: (a) NFT.CD is terminated with status Split; and (b) Two child NFTs, NFT.C and NFT.D, are generated.

(3) Merge NFTs into a New NFT

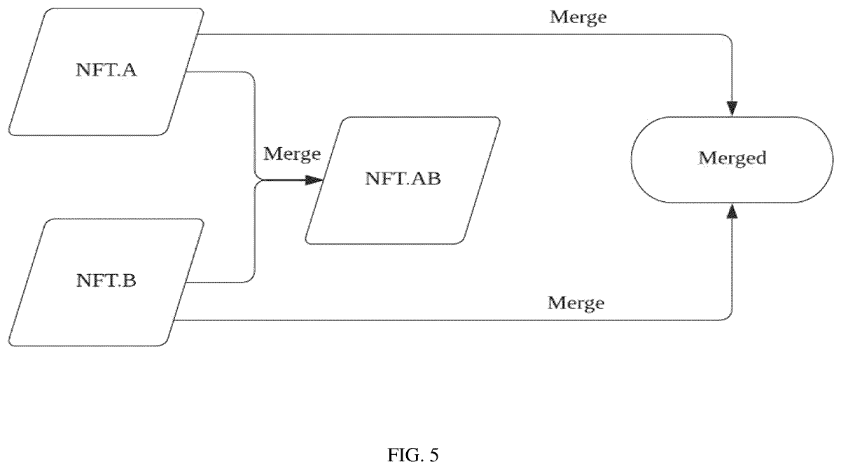

An NFT may be generated by merging several NFTs if these NFTs can be traced back to the same genesis NFT. Take the flowchart in FIG. 5 for example, in the process that NFT.A and NFT.B are merged into NFT.AB, the following events occur: (a) NFT.A and NFT.B are terminated with status Merged; and (b) A new NFT, NFT.AB, is generated.

Different NFT splitting rules may be applied to the generated NFTs. This may include but not limited to a rule which allows an NFT to split only once, or a rule allows an NFT only to split into pieces of a specific size. The applied splitting rule of the generated NFT is determined by the smart contract generating the NFT, and cannot be changed during the life cycle of the NFT. Similarly, the regulation of merging NFTs are also determined by the smart contract.

Several methods may be used to “terminate” an NFT during splitting or merging. In one embodiment, the terminated NFT is burned, but some token related information is retained in the split NFTs or merged NFT. In this embodiment, when every time a splitting operation is performed, the original NFT to be split is burned, and a plurality of split NFTs is minted; when every time a merging operation is performed, the original NFTs to be merged together are burned, and a merged NFT representing the merged portion is minted.

In another embodiment, the terminated NFT is locked in the smart contract until the condition to unlock this NFT is fulfilled. In this embodiment, when every time a splitting operation is performed, the original NFT to be split is locked, and a plurality of split NFTs is minted or unlocked based on the availability of such NFTs on the distributed ledger; and when every time a merging operation is performed, the original NFTs to be merged together are all locked, and a merged NFT representing the merged portion is minted or unlocked based on the availability of the merged NFT on this distributed ledger. During locking, the NFT may be transferred to the contract address of the smart contract, and the locked NFT may be transferred to a standard account of a user after unlocking.

In an alternative embodiment, an NFT may also be “terminated” without locking or burning the token itself, but marking a status of locked or inactive in its metadata.

### Ownership Management

In this system, methods for digital asset leasement among users may also be employed for better asset utilizations. A leasement is composed of a digital asset, an expiring date and an operations-while-expired which may be one of auto-renewal, return and revoke.

Compared to Transfer, a Lease function is a relatively sophisticated operation that accounts for smart contracts' help. The Lease operation is cooperated by three parties: the lessee, the lessor, and the smart contract. The NFT owner (lessor) requests the smart contract with an NFT token ID, a lessee's address, an expiration date and an operation-while-expired. Straightforwardly, the command means the owner is lending out the NFT token to the lessee until the expiration date, and the smart contract will execute its related operation(s) while expired.

The first example of operation-while-expired is Auto-renewal. This function may auto-renew the lease relationship while the NFT token expires if some conditions hold, such as acknowledged by both sides or more flexible conditions defined and supervised by smart contracts.

The second example of operation-while-expired is Return. This function may lead to a termination of the lease relationship while it expires. In general, this might be the default action upon expiration.

The third example of operation-while-expired is Revoke. This function may terminate the lease relationship before the expiration date if some regulations are found to be violated. The related rules may be detailed listed in the terms and conditions while entering this system. Besides revoke automatically, an authorized third party (e.g. the administrator) may also come into play to determine whether the regulations are violated and whether the revoke action should be executed.

If an NFT can be leased out, a user may have control to the NFT via leasement. A “holder” is the party currently has control to the NFT, no matter the party owns the NFT or leases the NFT. In contrast, an “owner” owns the NFT by minting a new one or receiving one from others (instead of receiving one from leasing). Therefore, an owner may keep all rights to manipulate the NFT (which is called “privileges”) based on the predefined rules, while the privileges of the holder may more or less be restricted.

### The Privileges and their Amending

“Privileges” are defined in rules during actions like minting, splitting, merging, or leasing. Examples of rule definitions include but not limited to the followings. Privileges are usually defined as rules and initialized while minting. The privilege may be verified before executing smart contract functions. Once the privilege is verified, a user may call the smart contract functions, and may be allowed to put additional constraints to the privilege for further usages.

In Split function, the rules may include (a) not splittable, (b) can be split only once, or (c) can be split more than once. In Merge function, the rules may (a) NFTs are allowed to be merged together if they originated from the same genesis NFT, and (b) NFTs are allowed to be merged together only if they split from the same parent NFT (i.e., have a common parent in last generation). In Lease function, the rules may include (a) leasable, and (b) not leasable.

In general, the rules become more rigorous when the generation of NFT increases. In splitting and leasing actions a new NFT inherits the privilege from its parent NFT if not specified. If it is defined along with the function call, it could only be more rigorous or equal to that of the parent NFT. For example, a parent NFT which is not allowed to be leased out cannot be split into leasable child NFTs. In merging action the privilege will be equal to or less than that of the closest (with minimum generation difference) NFT containing the same segmentation portions.

Several examples are provided below for the purpose of better understanding. Assume an NFT, NFT.AB, is owned by a user, Alice, and is originally splitable.

In Case 1, Alice splits NFT.AB into NFT.A and NFT.B, and meanwhile disables splittable property thereof so that neither NFT.A nor NFT.B can be split further.

In Case 2, Alice leases NFT.AB to Bob. In the first embodiment, Alice does not allow Bob to operate further so that she disables all privileges including leasing, splitting and merging. In the second embodiment, Alice does not limit Bob's operation, but the NFT has to be returned in the original manner (not split, not leased, not merged with other NFTs). The recovery process will be executed automatically by the smart contract.

In Case 3, Alice merges NFT.AB and NFT.CD into NFT.ABCD (NFT.AB and NFT.CD come from the same genesis NFT). The merged NFT.ABCD will inherit the privilege from the latest NFTs which contains segments AB and CD.

### Data Schema

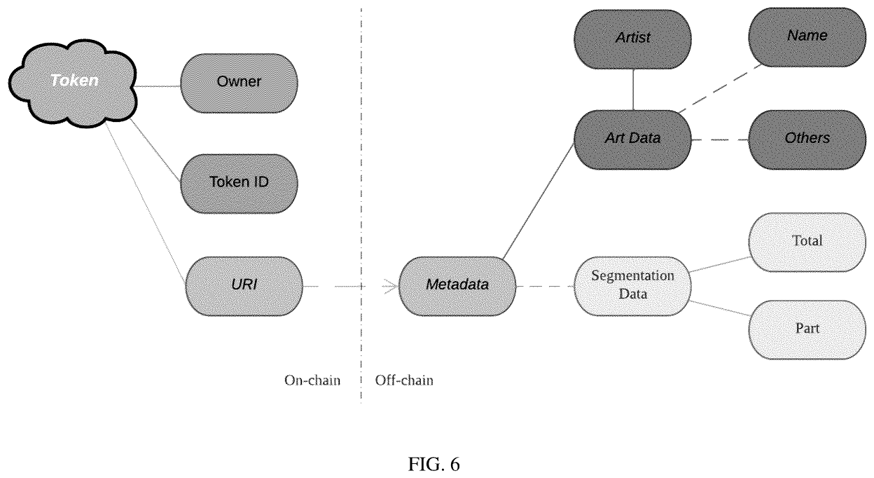

FIG. 6 depicts the data schema of NFTs. The data structure comprises on-chain data and off-chain data. The on-chain data comprises a “Token”, which is the NFT token that composed of a tuple. The Token comprises Owner, Token ID and URI. “Owner” part is the owner's address on the blockchain. It will be overwritten by the smart contract while transferred. In the case where leasing functions are available, it will also be overwritten by the smart contract while leased, returned and revoked. “Token ID” is the NFT token ID generated by the smart contract. Token ID is used to distinguish NFTs in a smart contract instance on a blockchain. It is immutable once generated. “URI” part indicates an off-chain metadata which records detailed information about the digital asset. It is also immutable.

Because the on-chain storage is valuable, most detailed information about the digital assets are kept in off-chain databases. The link between on-chain data and off-chain data relies on the URI attribute recorded in the NFT, which will indicate the off-chain metadata. On one hand, the separated design keeps on-chain data brief; on the other hand, the off-chain data could be flexible to support different data schemas in different scenarios. The fields of off-chain data are not mandatory. In a specific example provided in this application, the NFTs are linked to fine arts in famous museums so it may contain some art related information.

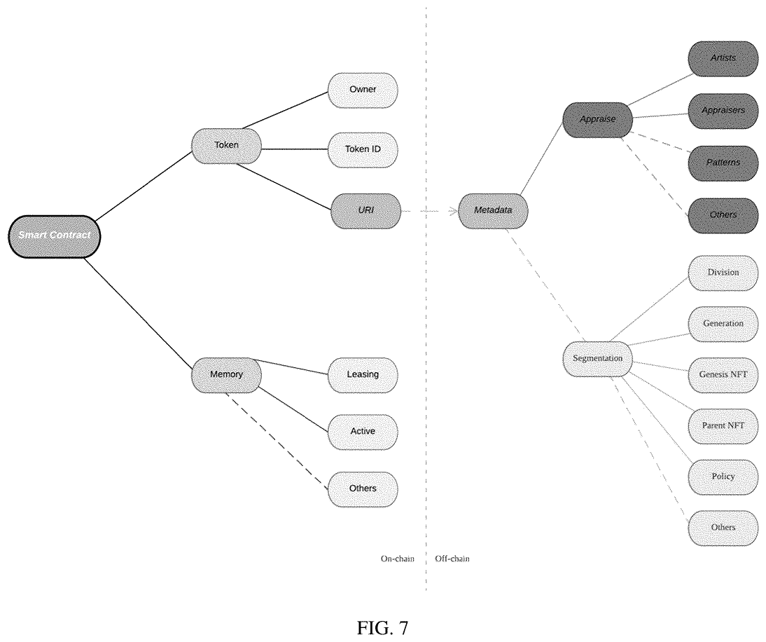

FIG. 7 is an alternative embodiment of NFT data schema. In this embodiment, the on-chain data further comprises a blockchain memory part. The blockchain memory is the memory of nodes that run the blockchain program. The blockchain memory may record some current-status related flexible data like splitting, merging and leasing.

### Examples of NFT Operations on a Single Chain

The followings are some examples showing how the NFT data looks like and locates. The smart contracts are executable programs running on all blockchain nodes. NFTs are immutable data generated by the smart contract, which are stored as blockchain data and regarded as transferable tokens of assets. However, most practical data related to an NFT are not stored on the blockchain. There is a metadata URI record in the NFT, which will refer to an off-chain storage that keeps detailed information. Along with the NFT management, there are some modifiable data stored in the blockchain memory to record the current status like leasing, splitting and merging. Finally, since the space on blockchain is quite valuable, most detailed data are stored in an off-chain manner. The off-chain data are ideally immutable, but it is not mandatorily.

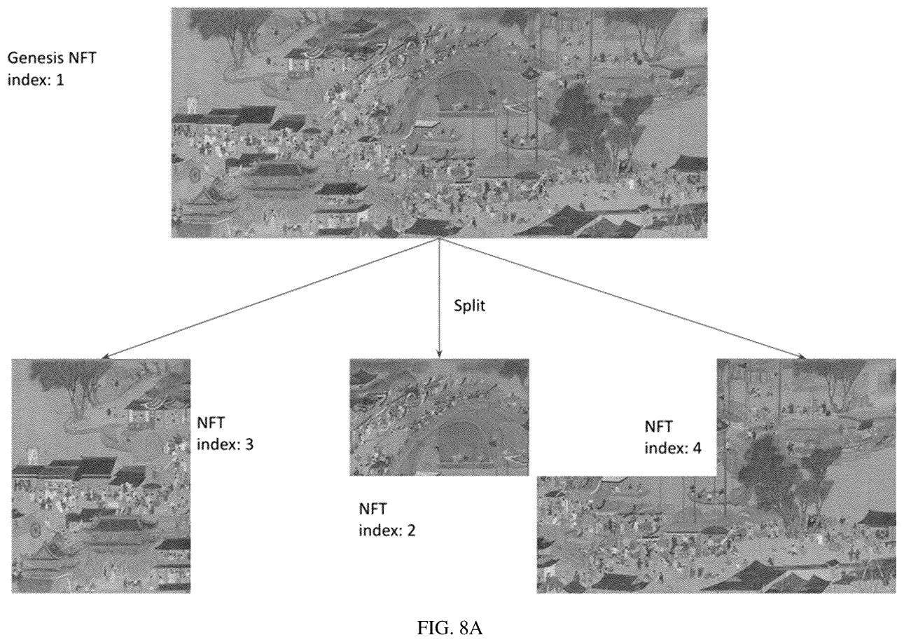

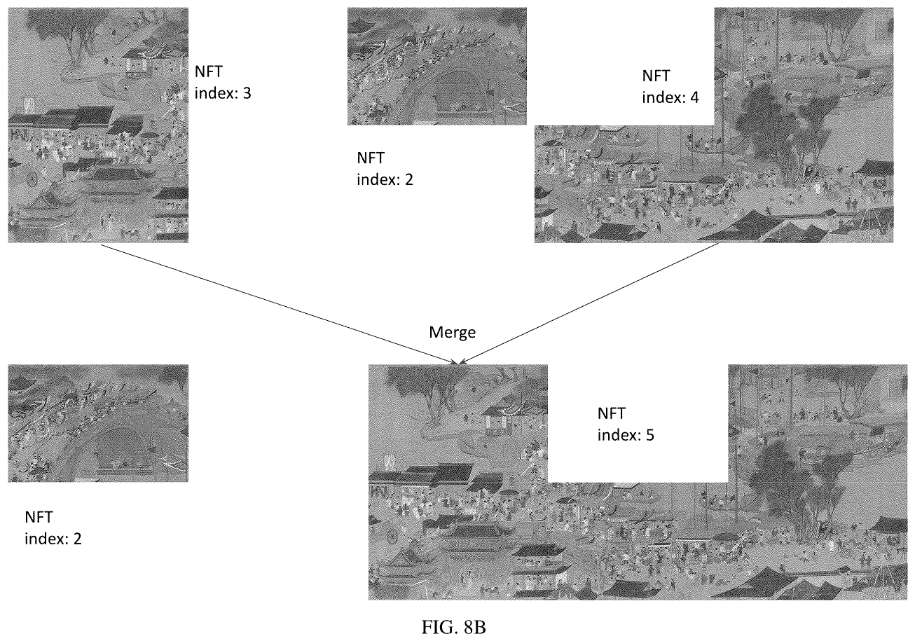

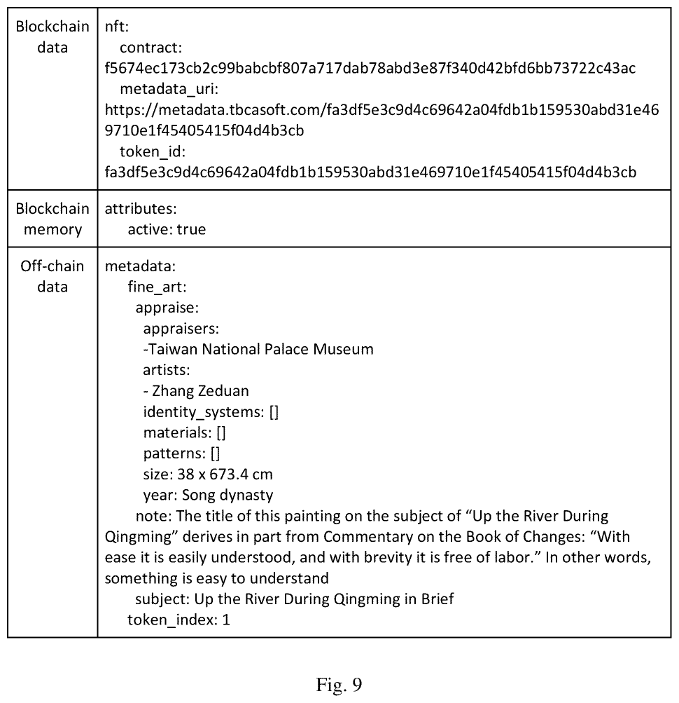

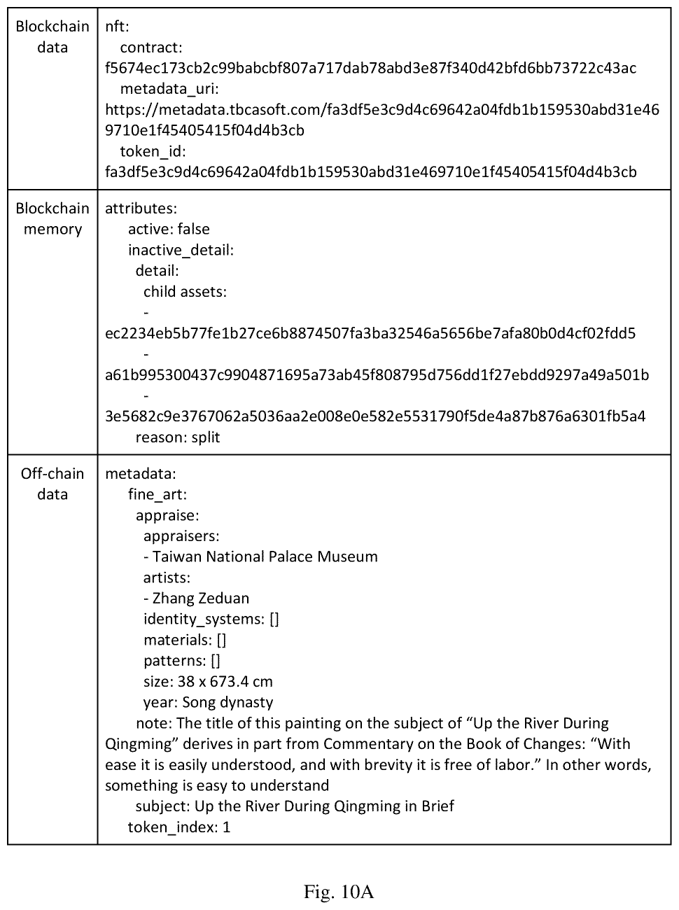

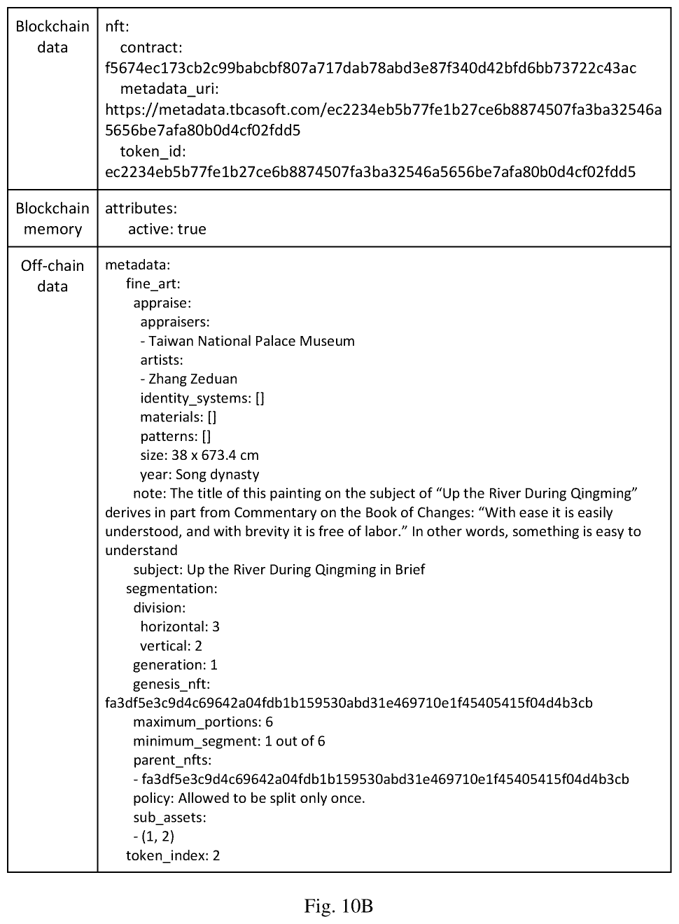

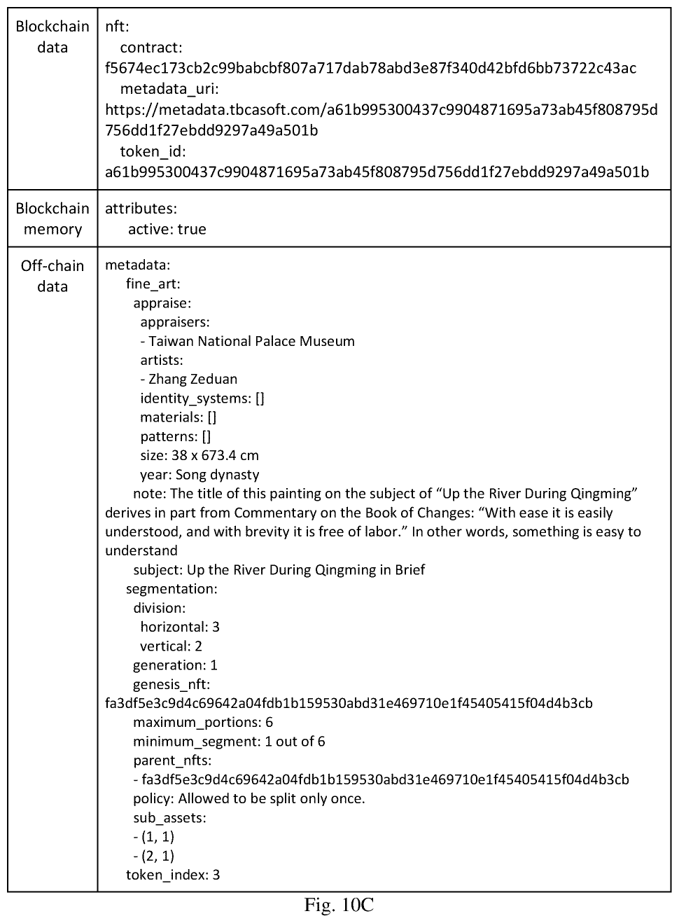

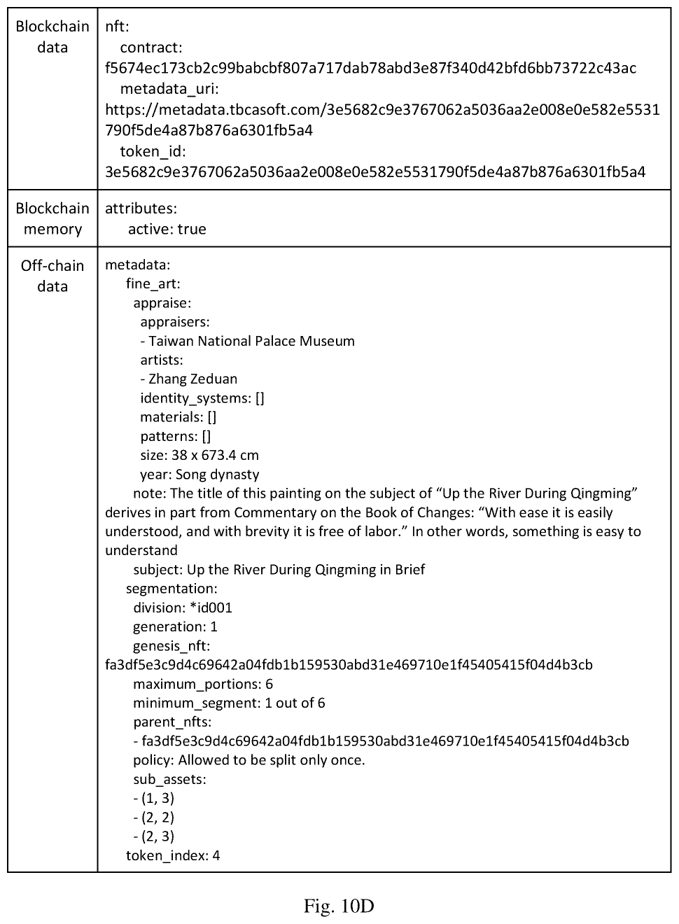

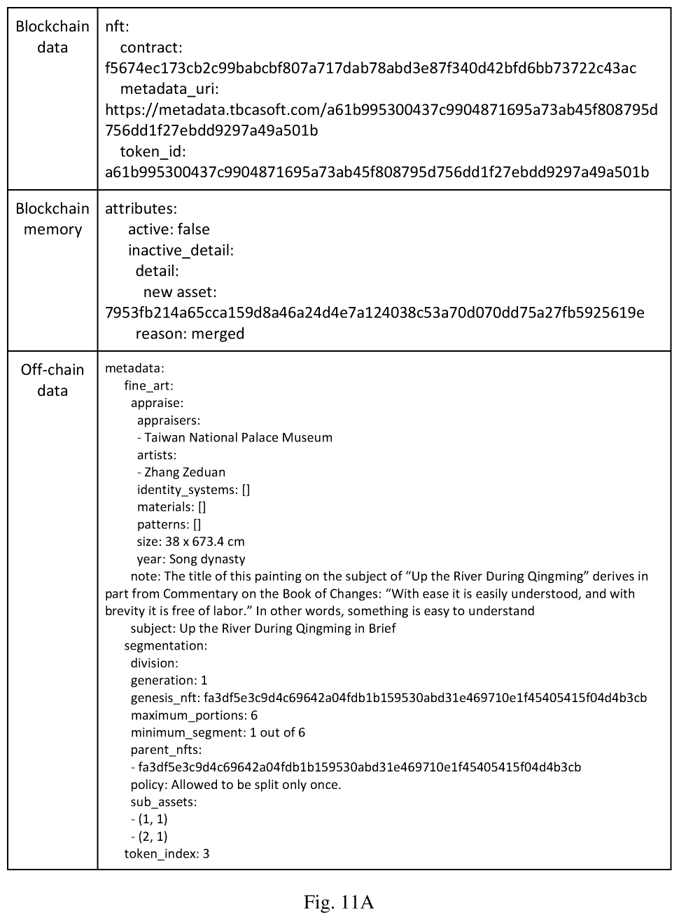

FIG. 8A and FIG. 8B show an example of NFT linked with a fine art in a museum. The newly minted genesis NFT with index number of 1 is then split into 3 child NFTs with index numbers of 2, 3 and 4. The child NFTs with index numbers of 3 and 4 are then merged together to generate a merged NFT with the index of 5. FIG. 9 is an example showing the data stored on blockchain, on blockchain memory, and stored off-chain when minting a new genesis NFT. FIG. 10A shows the data changes of the genesis NFT (index: 1) after split and inactivated. The active status and the split child NFTs are recorded on blockchain memory. FIGS. 10B, 10C and 10D are the data of child NFTs with index numbers of 2, 3 and 4, respectively.

The genesis NFT token ID and segmentation information (such as generation number, genesis NFT, maximum splitting portions and parent NFT) are recorded in form of off-chain data. In this example, the image of the genesis NFT is divided in both horizontal and vertical directions. This is recorded by a horizontal segmentation number and a vertical segmentation number as shown in “division” of the off-chain data in FIGS. 10B and 10C. The two segmentation numbers determines the smallest splitting unit which may be generated from the genesis NFT, which can be seen in “maximum_portions” and “minimum_segment”. In other words, the genesis NFT is configured to be split into a plurality of child NFTs based on the splitting rule, and each of the plurality of child NFTs comprises one or more smallest splitting units of the genesis NFT. Also, the location of the split NFT relative to the image of genesis NFT may be provided as a coordinate, as shown in “sub_assets” of the off-chain data in FIGS. 10B and 10C.

The splitting rule may further comprise a splitting times which determines a maximum number of times the genesis NFT can be split. As shown in the “policy” of the off-chain data in FIGS. 10B and 10C, the NFT in this example is allowed to be split only once

The metadata of the genesis NFT may comprise a genesis image (in this example, an image of a fine art in museum), and the metadata of each of its child NFTs comprises a child image represents a portion of the genesis image.

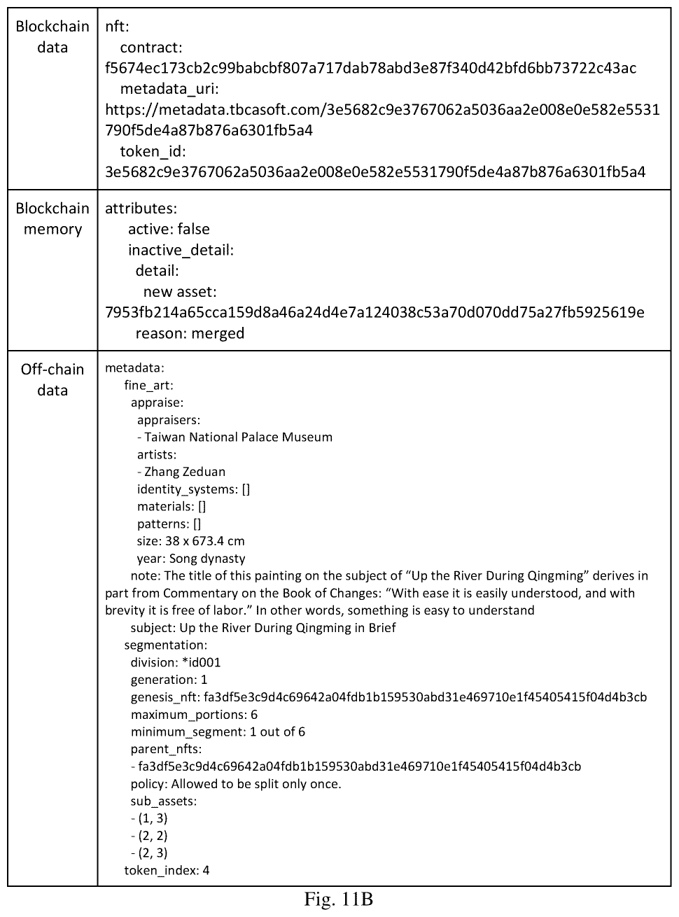

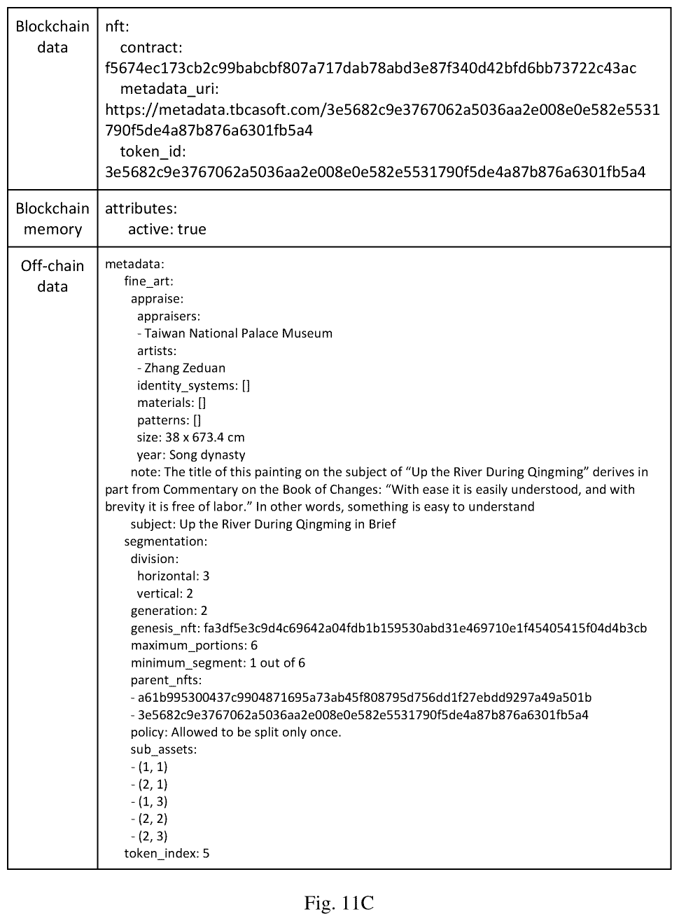

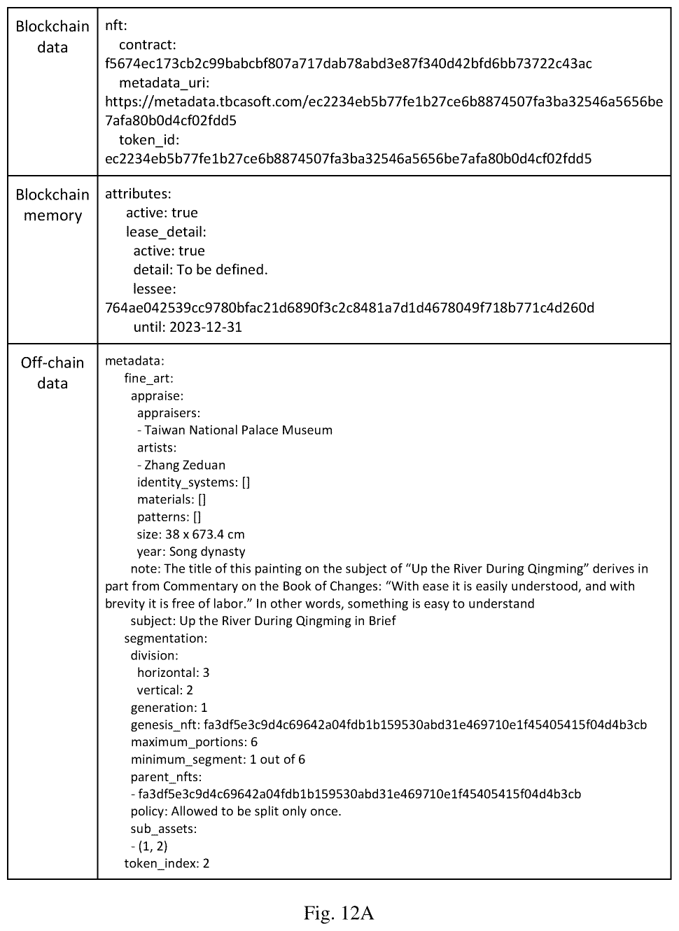

FIGS. 11A and 11B shows the data changes of the NFTs with index numbers of 3 and 4, respectively. The active status and the token ID of merged NFT are recorded on blockchain memory. FIG. 11C is the data of the merged NFT with index number of 5. The genesis NFT token ID and segmentation information are recorded in form off-chain data.

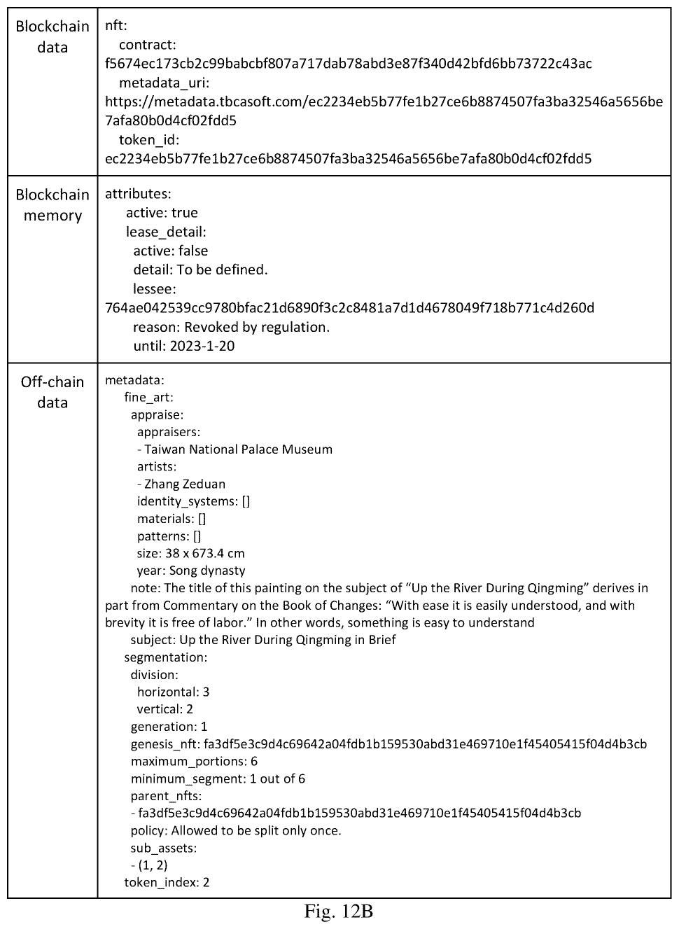

FIG. 12A shows the data changes of the NFT (index: 2) in NFT leasement, and FIG. 12B shows the data changes when the leasement is revoked. For example, when the NFT is leased to the address of “764ae042539cc9780bfac21d6890f3c2c8481a7d1d4678049f718b771c4d260d”, the lessee and the due date are recorded on the blockchain memory. When revocation occurs, the information related to revocation is also recorded on the blockchain memory. In other words, the lease operation only changes the data in the blockchain memory.

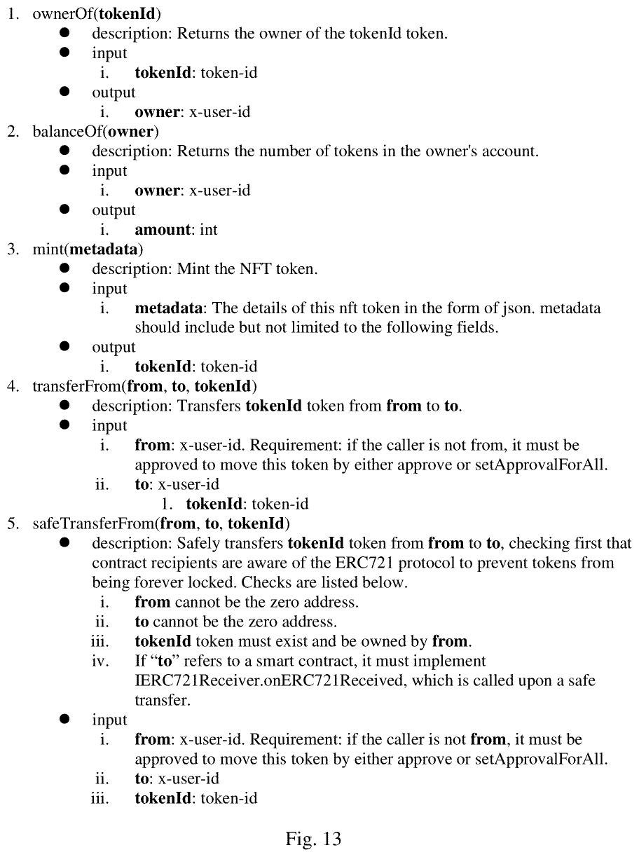

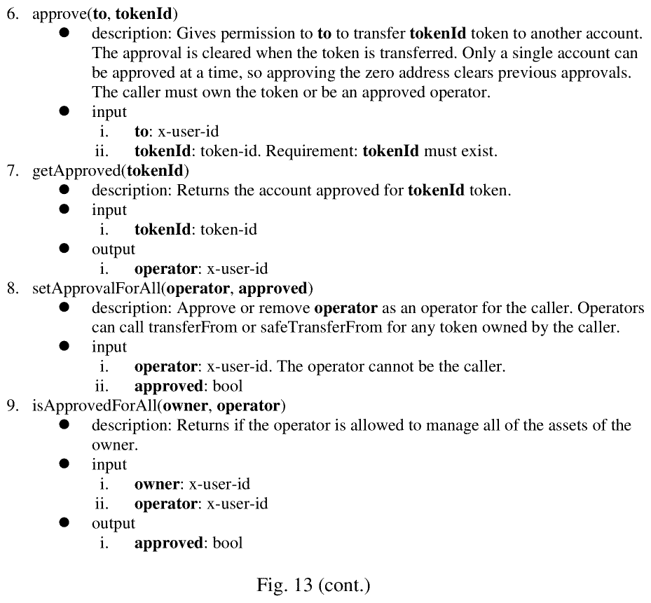

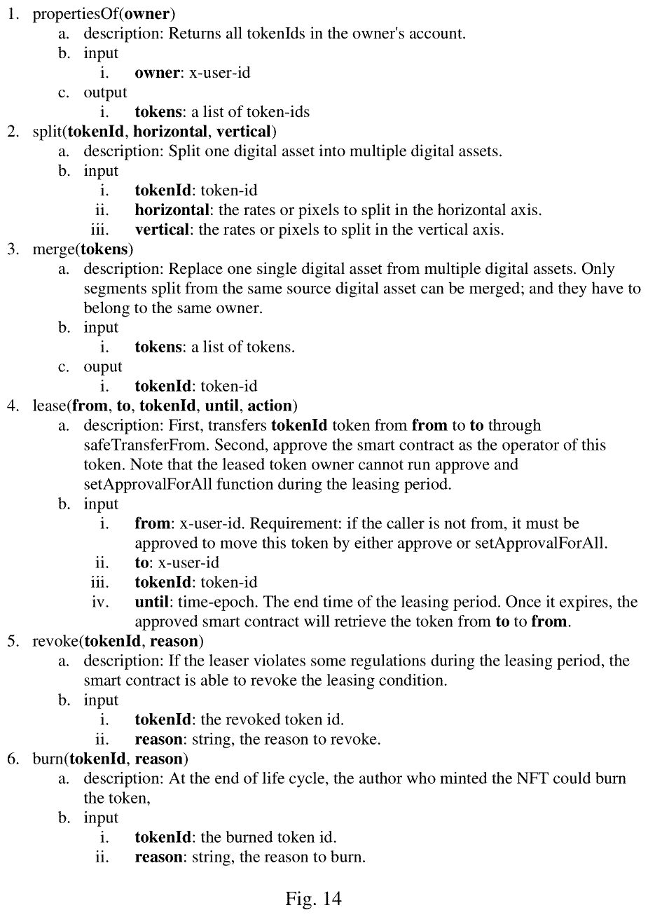

The functional calls implemented in the above example are as shown in FIGS. 13-14. FIG. 13 lists ERC721 functions, and FIG. 14 lists customized functions.

### Cross-Chain Features for Splittable NFTs

Because NFTs may live on different distributed ledgers, a trusty method for cross-chain NFT transfer is desired to improve the liquidity of NFT assets. For cross-chain techniques, PCT International Patent Publication No. WO2019/125506 describes methods for cross-ledger transfers between distributed ledgers, and is incorporated herein by reference.

Generally speaking, a cross-chain transfer includes locking the NFT on one distributed ledger, and generating a corresponding NFT on another distributed ledger. The ledger where the NFT originally exists on is called the “source distributed ledger”, and the ledger where the NFT is to be transferred to is called the “target distributed ledger”. The locking and generation steps are required to prevent double spending of the NFT. In more details, this may include identifying the NFT to be transferred (which is called the “source NFT”) from the source distributed ledger, locking the source NFT in the source distributed ledger by a smart contract, and generating a corresponding NFT (which is called the “target NFT”) in the target distributed ledger. As described above, to control the users eligible for issuing new NFTs, the blockchain generating genesis NFTs are preferably a private chain. However, the target distributed ledger where the source NFT transferred to may be either a private chain or a public chain.

However, the above features are not enough for splittable NFTs to perform cross-chain operations. Splittable NFTs should record an identifier uniquely linked to the genesis NFT and the rules of splitting and merging on every token of every generation, so that every token derived from the same genesis NFT can recognize each other to perform split/merge functions even after several rounds of split/merge/cross-chain operations. Therefore, a source NFT needs to contain a source NFT information to record essential information which can be tracked back to the genesis NFT. The essential information may comprise the splitting rule and a unique genesis NFT identifier. One example of the genesis NFT identifier is the token ID of the genesis NFT. The genesis NFT is the first minted NFT among all NFTs having the genesis NFT identifier. As such, a token can be tracked back to the genesis NFT which is the first minted one.

In cross-chain transfer, the source NFT may be inactivated by means of NFT locking or burning, and the target NFT may be generated by unlocking or minting with the aid of smart contract. The target NFT shall have the same splitting or merging ability as the source NFT. More specifically, the target NFT shall be able to be locked or burned upon receiving a splitting request complying with the splitting rule, and generate a plurality of split NFTs each having a split NFT information comprising at least part of the source NFT information based on the genesis NFT identifier and the splitting request. The target NFT shall also be able to be merged with other NFTs having the same genesis NFT identifier (which are called “sibling NFTs”) in the target distributed ledger if all of the sibling NFTs are owned by the same owner. The merging steps should include receiving a merging request to merge the target NFT with one or more sibling NFTs, locking or burning the target NFT and the one or more sibling NFTs in the target distributed ledger, generating a merged NFT. The merged NFT represent a larger piece merged from all pieces of the sibling NFTs to be merged, and will have a merged NFT information comprising the splitting rule and the genesis NFT identifier.

In one embodiment, the approach to inactivate the source NFT is locking instead of burning. This may comprise a locking transaction to lock the source NFT in a smart contract for transferring splittable NFTs from the source distributed ledger to the target distributed ledger, and the locked source NFT may only be unlocked after a foreign distributed ledger requests to transfer a foreign NFT corresponding to the source NFT from the foreign distributed ledger to the source distributed ledger. Here the foreign distributed ledger may be the same as the target distributed ledger, but it may also be different from the target distributed ledger. The only thing matters is that a previously active corresponding NFT has been inactivated before unlocking the source NFT.

As described above, the genesis NFT is the first minted NFT among all NFTs having the genesis NFT identifier. And both the source NFT and the target NFT may be referenced to the genesis NFT having the genesis NFT identifier and the splitting rule. The source NFT to be transferred may be the genesis NFT, but it may also be other than the genesis NFT. For example, the source NFT may be an NFT corresponding to the genesis NFT on other chain, which means that at least one cross-chain operation has been performed before. In another example, the source NFT may be a child NFT representing a portion of the genesis NFT, which means that at least one splitting operation has been performed before.

### Three-Transaction Cross-Ledger Transfer Which Prevents Double Spending

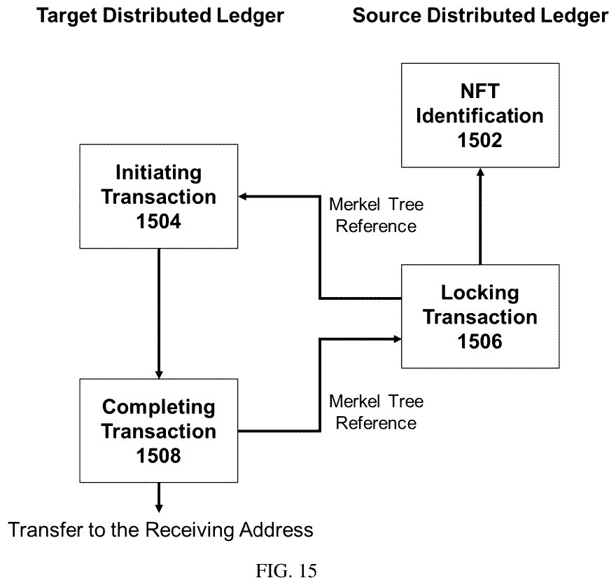

To further enhance the system's ability to prevent double spending, the method depicted in FIG. 15 is provided to transfer digital assets between distributed ledgers. The cross-ledger transfer is performed in a way which guarantees, via a series of handshakes, that the value cannot be created out of nowhere by transferring the source NFT in the source distributed ledger in more than one target distributed ledger.

As shown in FIG. 15, an exemplary implementation of such a cross-ledger transfer may generate and commit a series of three individual transactions to the distributed ledgers of the system. These transactions include an initiating transaction in the target distributed ledger; a locking transaction in the source distributed ledger; and a completing transaction in the target distributed ledger.

In a first stage of the method which transfers digital assets between distributed ledgers, the source NFT to be transferred in the source distributed ledger is found or identified in NFT identification step 1502. It is this source NFT in the source distributed ledger that is to be transferred to the target distributed ledger.

In a second stage of the method, an initiating transaction 1504 is generated and committed to the target distributed ledger. The initiating transaction 1504 creates the same digitally-represented token (e.g., minting a target NFT corresponding to the source NFT in the target distributed ledger) as the identified token of the NFT identification 1502. However, in accordance with an embodiment of the invention, the initiating transaction 1504 has a special property in that generated token cannot be transferred to other address in a normal manner. (More particularly, the generated token of the initiating transaction 1504 can only be transferred by a completing transaction 1508 that references the locking transaction 1506 which references the initiating transaction 1504 and locks the identified token of the NFT identification 1502.)

In a third stage of the method, after the initiating transaction 1504 is committed to the target distributed ledger, a locking transaction 1506 is generated and committed to the source distributed ledger. The transaction input of the locking transaction 1506 is the source NFT identified in step 1502 in the source distributed ledger. As such, the locking transaction 1506 locks the identified source NFT in step 1502 so that it becomes a locked NFT (and so no longer transferrable) in the source distributed ledger. This can be done by burning or locking the source NFT by a smart contract. In effect, the locking transaction 1506 locks the source NFT identified in NFT identification 1502 such that it is never transferred, split or merged in the source distributed ledger.

Furthermore, the locking transaction 1506 references the initiating transaction 1504 in the target distributed ledger (for example, by providing the entire initiating transaction and the Merkle root and branch hashes for verifying the existence of the initiating transaction in the target block). This “Merkle reference” from the locking transaction 1506 to the initiating transaction 1504 is used to prevent the identified NFT from being transferred to multiple addresses.

In a fourth stage of the method, after the locking transaction 1506 is committed to the source distributed ledger, a completing transaction 1508 is generated and committed to the target distributed ledger. A valid completing transaction 1508 transfers the target NFT created by the initiating transaction 1504 based on the smart contract.

In order to be valid, the completing transaction 1508 must reference the locking transaction 1506 (for example, by providing the entire locking transaction and the Merkle root and branch hashes that may be used to verify the existence of the locking transaction in the source block) which locks the identified source NFT in the smart contract. Because the output of the locking transaction 1506 cannot be transferred by any user, the existence of the locking transaction 1506 in the source distributed ledger provides a guarantee that the identified source NFT has been, in effect, extinguished in the source distributed ledger.

It is not possible to commit more than one completing transaction 1508. This is because the completing transaction 1508 is only valid if it transfers (by way of its transaction input) the target NFT of the initiating transaction 1504 which is referenced by the locking transaction 1506. Hence, if the NFT being transferred by the completing transaction 1508 is not the NFT of the initiating transaction 1504 referenced by the locking transaction 1506, then the completing transaction 1508 is invalid and so is prevented from being committed to the target distributed ledger.

The transfer of a valid completing transaction 1508 represents the completion of the cross-ledger digitally-represented token transfer to a recipient in the target distributed ledger. The transfer of the completing transaction 1508 may be used normally within the target distributed ledger by the recipient. In other words, once the completing transaction is committed to the target distributed ledger, the target NFT of the completing transaction may be used within the target distributed ledger without needing to further reference any transaction in the source distributed ledger.

### System Architectures Supporting Three-Transaction Cross-Ledger Transfer

In a distributed ledger, the nodes containing a complete and up-to-date copy of the data of the distributed ledger are referred to as full nodes. In contrast, some lightweight nodes do not maintain a complete and up-to-date copy of the distributed ledger, but still have the capability to verify transactions in the distributed ledger. One example is payment verification (PV) nodes which may verify transactions using a payment verification method. A PV node may be a non-full node that is connected to the distributed ledger network and holds the data required to prove the validity of a transaction in the distributed ledger. Individual transaction records are generally missing from the data at a PV node, so the PV node may be considered to be a client of a distributed ledger network. In an exemplary implementation, when the distributed ledger is a blockchain, the PV node may be a simplified payment verification (SPV) node, and the required data includes a Merkle root of the transactions in the block, the previous block hash, and a list of block signatures created by block validators.

One system architecture that may be used to support cross-ledger transfers may have each full node of the source distributed ledger also be a full node of the target distributed ledger. Although such a full-overlapping system architecture would support cross-ledger transfers, it would require substantial extra resources at each node.

Disclosed herein are exemplary system architectures which support cross-ledger transfers while requiring less resources than a fully-overlapping system architecture. A first exemplary system architecture embeds foreign payment verification (PV) nodes into distributed ledger networks. A second exemplary system architecture utilizes a set of shared full nodes while not having every node be a shared node.

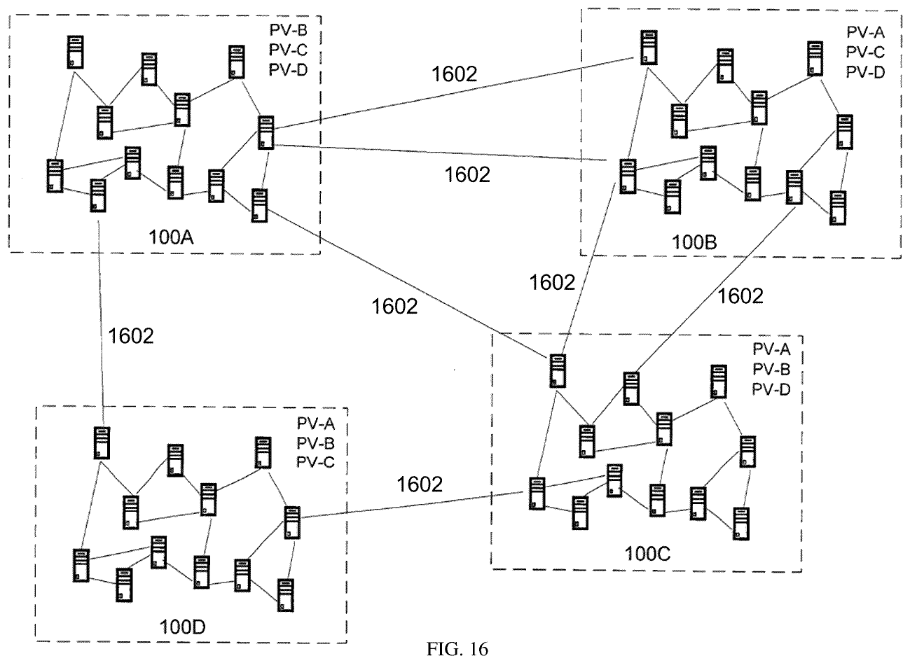

In a first exemplary system architecture depicted in FIG. 16, payment verification (PV) nodes for other (i.e. foreign) distributed ledgers are co-located at all, or a portion of, nodes in each distributed ledger network of the multiple distributed ledger system. The co-located PV nodes are used to support cross-ledger payment verification.

To reduce the resources needed to implement the system, the PV nodes may be non-full nodes. In an exemplary implementation, each PV node may be implemented as a simplified payment verification (SPV) node. Furthermore, while a multiple distributed ledger system with four ledgers is depicted in FIG. 16, a multiple distributed ledger system may include any number of distributed ledgers.

In the example shown in FIG. 16, a first distributed ledger A is maintained by a first distributed ledger network 100A, a second distributed ledger B is maintained by a second distributed ledger network 100B, a third distributed ledger C is maintained by a third distributed ledger network 100C, and a fourth distributed ledger D is maintained by a fourth distributed ledger network 100D. Each of these distributed ledger networks (100A, 100B, 100C and 100D) includes its own nodes with interconnections therebetween. In addition, in accordance with an embodiment of the invention, there are further communicative interconnections 1602 between some nodes in the different consensus networks so as to communicatively interconnect the consensus networks (100A, 100B, 100C and 100D).

However, merely communicatively interconnecting the distributed ledger networks of the ledgers is insufficient because inter-ledger transaction submission and verification are also needed to support cross-ledger transfers. For this reason, at least some of the nodes in each distributed ledger network may be configured to run both a “local” full node-stack for its own distributed ledger and a “foreign” PV node-stack for the other ledgers with which it is to interact.

A full node-stack for a distributed ledger includes a set of software routines or programs at a full node of the distributed ledger network. The set of software routines or programs performs tasks and/or functions relating to the distributed ledger, including, if applicable: converting API (application program interface) requests to distributed ledger transactions; managing user keys; signing transactions; notifying other systems when transactions are committed; submitting transactions to the distributed ledger; and providing proofs of inclusion for transactions. A PV node-stack for a distributed ledger includes a reduced set of software routines or programs at a client communicating with the distributed ledger network. The reduced set of software routines or programs performs tasks and/or functions including: providing proofs of inclusion for transactions; and submitting transactions to the distributed ledger.

In the example of FIG. 16, at least some of the nodes in the first network 100A have been configured to also run PV nodes (PV-B, PV-C and PV-D) for each of the second, third and fourth networks (100B, 100C and 100D). Similarly, at least some of the nodes in the second network 100B have been configured to also run PV nodes (PV-A, PV-C and PV-D) for each of the first, third and fourth networks (100A, 100C and 100D). Also, at least some of the nodes in the third network 100C have been configured to also run PV nodes (PV-A, PV-B and PV-D) for each of the first, second and fourth networks (100A, 100B and 100D). Finally, at least some of the nodes in the fourth network 100D have been configured to also run PV nodes (PV-A, PV-B and PV-C) for each of the first, second and third networks (100A, 100B and 100C).

Each PV-A node maintains a chain of block headers and signatures (i.e. a block header/signature chain) for co-ledger A. Similarly, each PV-B node maintains a block header/signature chain for co-ledger B, each PV-C node maintains a block header/signature chain for co-ledger C, and each PV-D node maintains a block header/signature chain for co-ledger D.

The computer system in this example includes a full node-stack A for the local distributed ledger A. The full node-stack A includes a complete copy of the local distributed ledger A. In addition, the computer system includes a SPV node-stack B for the foreign distributed ledger B, a SPV node-stack C for the foreign distributed ledger C, and a SPV node-stack D for the foreign distributed ledger D. The SPV node-stack B includes a block header/signature chain for the foreign distributed ledger B. The SPV node-stack C includes a block header/signature chain for the foreign distributed ledger C. And the SPV node-stack D includes a block header/signature chain for the foreign distributed ledger D.

The structure of a block header/signature chain that may be maintained at a PV node, particularly a PV node implemented as an SPV node may include the block headers and the block signatures of the relevant distributed ledger, where the block signature is a signature by a block validator of the relevant distributed ledger network which indicates that the validator accepts that the block that is signed is valid.

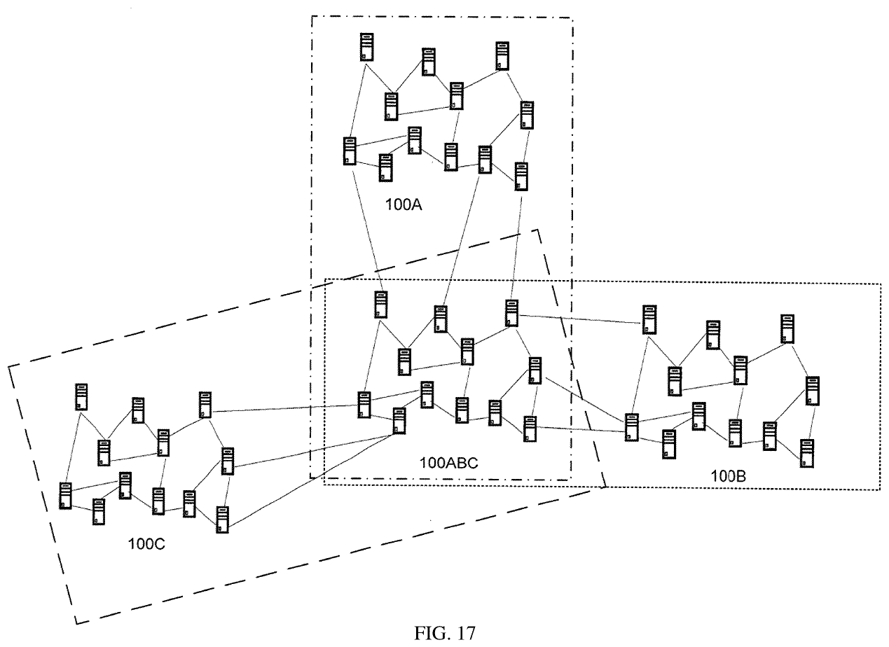

In a second exemplary system architecture depicted in FIG. 17, a set of nodes are shared by all the distributed ledger networks in the multiple distributed ledger system. Each of these shared nodes may operate as a full node for all the ledgers of the multiple distributed ledger system so as to efficiently support cross-ledger transfers. Note that, while a multiple distributed ledger system with three ledgers is depicted in FIG. 17, any number of ledgers may be included in the system. In the example shown in FIG. 17, a first distributed ledger A is maintained by a first distributed ledger network 100A, a second distributed ledger B is maintained by a second distributed ledger network 100B, and a third distributed ledger C is maintained by a third distributed ledger network 100C. Each of these distributed ledger networks (100A, 100B, and 100C) includes nodes with interconnections herebetween.

In accordance with an embodiment of the invention, there is a shared set of full nodes (100ABC). Each node in the shared set 100ABC is operational as a full node of each of the three distributed ledger networks (100A, 100B, and 100C). As such, each node in the shared set 100ABC contains a copy of each of the three distributed ledgers (A, B and C). Note that the three distributed ledgers (A, B, C) remain separate distributed ledgers, each recording a separate ledger of transactions.

In accordance with an embodiment of the invention, an index of block hashes to block headers for each distributed ledger in the system may be created from the distributed ledger data and provided at each node in the shared set of full nodes (100ABC). The index may be used for the Merkle tree referencing depicted in FIG. 15 (from locking transaction 1506 to initiating transaction 1504, and from completing transaction 1508 to locking transaction 1506) so as to perform inter-ledger verification.

Any participant node may send a query through the network to a node of the shared set of full nodes (100ABC) to verify cross-ledger transactions. This implies a trust in a central entity or other trusted entry to guarantee or certify that the provided full nodes for the ledgers are not lying about the contents of the ledgers.

The computer system in this example includes a full node-stack A for the local distributed ledger A, a full node-stack B for the local distributed ledger B, and a full node-stack C for the local distributed ledger C. The full node-stack A includes a complete copy of the local distributed ledger A. The full node-stack B includes a complete copy of the local distributed ledger B. And the full node-stack C includes a complete copy of the local distributed ledger C.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein but is to be accorded the widest scope consistent with the principles and novel features disclosed herein. It is contemplated that additional embodiments are within the spirit and true scope of the disclosed subject matter. Thus, it is intended that the present invention covers modifications and variations that come within the scope of the appended claims and their equivalents.

What is claimed is:

1. A method for transferring splittable, non-fungible tokens (NFTs) from a source distributed ledger to a target distributed ledger different from the source distributed ledger, comprising:
identifying from the source distributed ledger, a source NFT having a source NFT information comprising a splitting rule and a genesis NFT identifier;
locking or burning, by a locking transaction, the source NFT in the source distributed ledger; and
unlocking or minting, by a completing transaction, a target NFT corresponding to the source NFT in the target distributed ledger, wherein the target NFT comprises the source NFT information to enable splitting or merging of the target NFT in the target distributed ledger.

2. The method of claim 1, wherein:
before locking or burning the source NFT by the locking transaction further comprising:
generating and submitting an initiating transaction for commission to the target distributed ledger, wherein the initiating transaction comprises the target NFT; and
generating and submitting the locking transaction for commission to the source distributed ledger; and
before unlocking or minting the target NFT by the completing transaction further comprising:
referencing, by the locking transaction, the initiating transaction in the target distributed ledger to verify the existence of the initiating transaction; and
generating and submitting the completing transaction for commission to the target distributed ledger.

3. The method of claim 1, wherein the splitting of the target NFT comprises the steps of:
after receiving a splitting request complying with the splitting rule, locking or burning the target NFT in the target distributed ledger; and
based on the genesis NFT identifier and the splitting request, generating a plurality of split NFTs each having a split NFT information comprising at least part of the source NFT information;
wherein the split NFT information of each of the plurality of split NFTs comprises the splitting rule and the genesis NFT identifier.

4. The method of claim 1, wherein the merging of the target NFT comprises the steps of:
receiving a merging request to merge the target NFT with one or more sibling NFTs having the same genesis NFT identifier and the same owner as the target NFT;
locking or burning the target NFT and the one or more sibling NFTs in the target distributed ledger; and
generating a merged NFT having a merged NFT information comprising at least part of the source NFT information;
wherein the merged NFT information of the merged NFT comprises the splitting rule and the genesis NFT identifier.

5. The method of claim 1, wherein both the source NFT and the target NFT are referenced to a genesis NFT having the genesis NFT identifier and the splitting rule;
and wherein the genesis NFT is the first minted NFT among all NFTs having the genesis NFT identifier.

6. The method of claim 5, wherein the source NFT is the genesis NFT.

7. The method of claim 5, wherein neither the source NFT nor the target NFT are the genesis NFT.

8. The method of claim 5, wherein the genesis NFT identifier is the token ID of the genesis NFT.

9. The method of claim 5, wherein the splitting rule determines a smallest splitting unit of the genesis NFT.

10. The method of claim 9, wherein the smallest splitting unit is determined by a horizontal segmentation number and a vertical segmentation number.

11. The method of claim 9, wherein the splitting rule further comprises a splitting times which determines a maximum number of times the genesis NFT can be split.

12. The method of claim 9, wherein the genesis NFT is configured to be split into a plurality of child NFTs based on the splitting rule, and each of the plurality of child NFTs comprises one or more smallest splitting units of the genesis NFT.

13. The method of claim 12, wherein the metadata of the genesis NFT comprises a genesis image, and the metadata of each of the plurality of child NFTs comprises a child image represents a portion of the genesis image.

14. The method of claim 1, wherein the locking transaction locks the source NFT in a smart contract for transferring splittable NFTs from a source distributed ledger to a target distributed ledger, and
wherein the locked source NFT is unlocked only after a foreign distributed ledger requests to transfer a foreign NFT corresponding to the source NFT from the foreign distributed ledger to the source distributed ledger.

15. The method of claim 14, wherein the foreign distributed ledger is the same as the target distributed ledger.

16. The method of claim 14, wherein the foreign distributed ledger is different from the target distributed ledger.

17. The method of claim 2, wherein the target NFT generated in the initiating transaction is only transferrable by the completing transaction when the completing transaction references the locking transaction and when the target NFT information of the target NFT in the initiating transaction matches with the source NFT information of the source NFT identified in the source distributed ledger.

18. The method of claim 17, wherein the completing transaction uses a Merkle tree reference to reference the locking transaction.

19. The method of claim 2, wherein the method is performed by a node-stack of the source distributed ledger.

20. The method of claim 19, wherein the initiating transaction and the completing transaction are submitted to a node-stack of the target distributed ledger, and the node-stack of the target distributed ledger further submits the initiating and completing transactions to the target distributed ledger.

21. The method of claim 2, wherein the method is performed by a node-stack of the target distributed ledger.

22. The method of claim 21, wherein the locking transaction is submitted to a node-stack of the source distributed ledger, and the node-stack of the source distributed ledger further submits the locking transaction to the source distributed ledger.
